(19) United States
(12) Patent Application Publication
(10) Pub. No.: US 2011/0044352 A1
(43) Pub. Date: Feb. 24, 2011

(54) TECHNIQUE FOR DETERMINING A POINT-TO-MULTIPOINT TREE LINKING A ROOT NODE TO A PLURALITY OF LEAF NODES

(75) Inventors: Mohamad Chaitou, Paris (FR); Jean-Louis Le Roux, Lannion (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: FRANCE TELECOM, PARIS (FR)

(21) Appl. No.: 12/920,337

(22) PCT Filed: Mar. 3, 2009
(86) PCT No.: PCT/FR09/50345

§ 371 Date: Aug. 31, 2010

(30) Foreign Application Priority Data
Mar. 4, 2008 (FR) 0851387

(51) Int. Cl. H04L 12/56

(52) U.S. Cl. 370/408

(57) ABSTRACT

A method is provided for determining a point-to-multipoint tree connecting a root node to a plurality of leaf nodes (some nodes in different domains) used by a path calculation entity associated with a current domain. The method comprises receiving from at least one other path calculation entity associated with a downstream domain at least one message including a first set of identifiers including at least one identifier of a bunch of branches comprising at least one branch and a respective cost associated with said bunch, the bunch comprising at least one branch enabling connection to leaf nodes in downstream domains, and determining at least one new bunch of branches comprising at least one branch as a function of said at least one first set received, said new bunch of branches having a minimum cost and making it possible also to contact the leaf nodes of the current domain.

The invention relates to a technique for determining a point-to-multipoint tree connecting a root node to a plurality of leaf nodes, with at least some of the nodes in different domains.

The field of the invention is that of communications networks and more particularly connected-mode packet transport networks.

A multi-protocol label switching communications network known as an IP/MPLS network consists of a set of interconnected domains. A domain is a set of nodes of the same address management space. It may be an interior gateway protocol (IGP) area of the network of an operator or an autonomous system (AS) administered by an operator.

It is possible in such a network to determine a MPLS-TE (Multi-Protocol Label-Switching Traffic Engineering) P2P (point-to-point) connection between an input router and a destination router in different areas or autonomous systems in accordance with a particular cost criterion such as a shortest path criterion. There is provision for using PCE (path computation element) servers to determine an optimum connection. A PCE server is an entity adapted to determine point-to-point (P2P) connections or label switched paths (LSP) at the request of a client. The backward recursive PCE-based computation method defined in the Internet Engineering Task Force (IETF) document draft-ietf-pce-brpc-06.txt uses a plurality of PCE servers associated with respective different areas or autonomous systems to optimize the calculation of the inter-domain P2P connection using a recursive calculation technique. The calculation servers collaborate to calculate a shorter interdomain path. A P2P connection calculation request propagates from calculation server to calculation server, from that associated with the domain of the input router to that associated with the domain of the destination router. By convention, the calculation server associated with the domain of the input router is on the upstream side and that associated with the domain of the destination router is on the downstream side. A response message propagates in the reverse direction, each calculation server incorporating into the response message information relating to its own domain; the P2P connection determined in this way is the optimum according to the shortest path criterion. To be more precise, a calculation server PCEₙ associated with the domain of the destination node calculates a set of shorter paths each having as root an input edge node from among the input edge nodes of the domain n and as leaf the LSP MPLS-TE destination node. The combination of these paths is a multipoint-to-point path referred to as the virtual shortest path tree (VSPT). The multipoint-to-point path VSPIₙ calculated by the calculation server PCEₙ is sent to the upstream calculation server PCE₍ₙ₋₁₎. It includes the respective roots and costs of the point-to-point paths of the calculated multipoint-to-point path. Using the multipoint-to-point path supplied by a downstream calculation server and the topology of the domain i, the calculation server PCEᵢ calculates a set of shorter paths each of which has as root one of the input edge nodes from the set of input edge nodes of the domain i and as leaf the LSP MPLS-TE destination node. Multipoint-to-point paths are thus calculated progressively by the calculation servers up to the calculation server of the domain of the root node of the point-to-point path, which then determines a point-to-point path between the root node and the destination node according to a shortest path criterion.

Applying this method to determining a point-to-multipoint (P2MP) path including a root node and a plurality of leaf nodes in different domains makes it possible to determine a plurality of point-to-point (P2P) paths between the root node and the leaf nodes. This method therefore makes it possible to determine a shortest path tree minimizing the distance between the root node and each of the leaf nodes. However, it does not make it possible to minimize the number of links used and therefore the bandwidth consumed. Although longer than a first shorter path, a second path between the root node and a first leaf node may make it possible to connect to a second leaf node at lower cost. This method therefore has the drawback of not optimizing the use of resources in the various domains.

There is therefore a requirement for a technique for determining a point-to-multipoint path between a root node and a plurality of leaf nodes, at least some of which are in different domains, that optimizes the use of resources in the various domains.

The invention responds to this requirement by providing a method of determining a point-to-multipoint tree connecting a root node to a plurality of leaf nodes, at least some of the nodes being in different domains, executed by a path calculation entity associated with a domain known as the current domain, said method including:
a step of receiving from at least one other path calculation entity associated with a domain downstream of the current domain at least one message including a first set of identifiers including at least one identifier of a bunch of branches including at least one branch and a respective cost associated with said bunch, the bunch including at least one branch making it possible to connect to leaf nodes in downstream domains; and
a step of determining at least one new bunch of branches including at least one branch as a function of said at least one first set received, said new bunch of branches having a minimum cost and making it possible to connect to the leaf nodes of the current domain, if necessary.

A domain is a subset of a set of nodes administered by the same operator, either an IGP area or an autonomous system.

Each path calculation entity determines a new set of bunches of branches as a function of information relating to a set of bunches of branches received from one or more other path calculation entities, if necessary taking into account leaf nodes in the current domain, the set or sets of bunches of branches received, and topology information for the current domain, each bunch of branches of the new set being optimized as a function of a cost criterion. The expression bunch of branches refers to a set of point-to-point paths or point-to-multipoint paths. The bunch of branches may consist of a single branch, if it comes from a single root node, or a plurality of branches. Accordingly, a new set of bunches of branches determined by the path calculation entity associated with the domain of the root node is a point-to-multipoint (P2MP) tree connecting the root node to a plurality of leaf nodes at least some of which are in different domains, thus optimizing the use of network resources by complying with the given cost criterion. The cost criterion may correspond to the number of links used. Note that the invention may also be implemented using a cost criterion such as a shortest path criterion.

Thus there is determined for a given subset of input nodes in the current domain serving as roots a bunch of branches minimizing a cost criterion and making it possible to connect all leaf nodes in downstream domains and the current domain, if necessary.

If it is not desirable to provide topology information for the downstream domains, the information relating to the bunches of branches may be explicit or implicit. It includes a subset of input nodes of the downstream domain.

In a first implementation, the number of new bunches is limited to a predetermined number during the step of determining at least one new bunch.

To reduce the calculation time, it is possible to obtain suboptimal trees by limiting the number of subsets of input nodes.

In a second implementation, the new bunch is limited to one branch during the step of determining at least one new bunch.

To reduce the calculation time, it is possible to obtain sub-optimal trees by using only bunches of a single branch.

Moreover, the step of receiving at least one message including a first set of identifiers including at least one identifier of a bunch of branches including at least one branch and a respective cost associated with said bunch and of determining at least one new bunch of branches including at least one branch and then the step of sending a message including a second set of identifiers of the determined new bunch or bunches and a respective cost associated with said new bunch are executed successively from the downstream end to the upstream end by path calculation entities to a path calculation entity associated with the upstream domain including the root node.

The calculation entities cooperate to determine the point-to-multipoint tree up to the point where the path calculation entity responsible for the domain of the root node in turn determines a branch having as root the root node and as leaves the set of leaf nodes in the downstream domain and in the root domain, if necessary.

The method furthermore includes a step of sending a request to determine a point-to-multipoint tree to path calculation entities associated with domains downstream of the current domain before the receiving step.

The method is initiated by an initiator path calculation entity that sends in the upstream to downstream direction a request to determine the point-to-multipoint path. The request is forwarded from calculation entity to calculation entity. The response message is sent in the downstream to upstream direction as far as the initiating path calculation entity.

The invention also provides a path calculation entity associated with a domain, called the current domain, for determining a point-to-multipoint tree connecting a root node to a plurality of leaf nodes, at least some of the nodes being in different domains, said entity including:
means for receiving at least one message including a first set of identifiers including at least one identifier of a bunch of branches including at least one branch and a respective cost associated with said bunch from at least one other path calculation entity associated with a domain downstream of the current domain, the bunch of branches including at least one branch making it possible to connect to leaf nodes in downstream domains; and
means for determining at least one new bunch of branches including at least one branch as a function of the first sets received, said new bunch of branches having a minimum cost and making it possible to connect to the leaf nodes of the current domain, if necessary.

The invention further provides a system including a plurality of the above path calculation entities.

The invention further provides a communications network node including the above path calculation entity.

The invention further provides a computer program including instructions for executing the above method of determining a point-to-multipoint tree connecting a root node to a plurality of leaf nodes, at least some of the nodes being in different domains, when the program is executed by a processor.

The invention further provides a signal sent by a path calculation entity associated with a domain, said signal bearing a message including a set of identifiers including at least one identifier of a bunch of branches including at least one branch and a respective cost associated with said bunch, the bunch of branches including at least one branch making it possible to connect to leaf nodes in downstream domains and in said domain, if necessary.

The invention can be better understood with the aid of the following description of a method of one particular implementation of the invention given with reference to the appended drawings, in which:

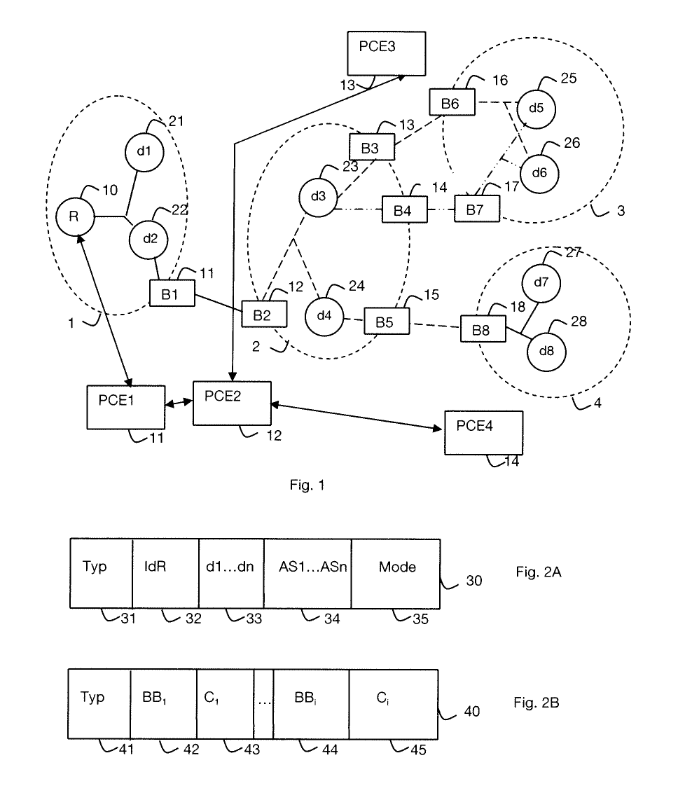

FIG. 1 is a diagram representing a network architecture in which the method of the invention is used;

FIG. 2A represents a request to determine a point-to-multipoint tree in one particular implementation of the invention;

FIG. 2B represents a response message to a point-to-multipoint tree determination request message in one particular implementation of the invention;

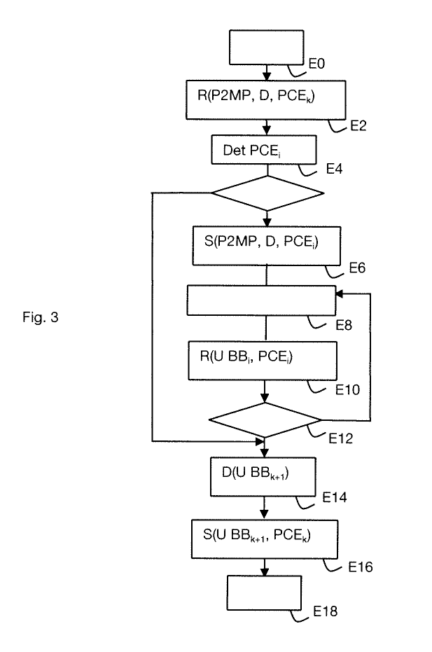

FIG. 3 represents the steps of the method of one particular implementation of the invention; and

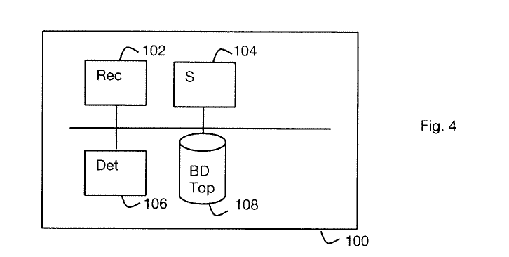

FIG. 4 represents a path calculation entity of one particular implementation of the invention.

The network architecture in which the method is used is described below with reference to FIG. 1. Four domains or autonomous systems (AS) 1 to 4 are shown. The first domain 1 includes a plurality of nodes of which four are represented in FIG. 1: a root node 10, labeled R, which is the root of a point-to-multipoint tree, two leaf nodes 21, 22, respectively labeled d1 and d2, and a border or output node 11, labeled B1. The output node B1 makes it possible to route traffic from the first domain 1 to the second domain 2 via an input node 12, labeled B2, in the second domain 2. The second domain 2 is downstream of the first domain 1. The second domain 2 includes a plurality of nodes, six of which are represented in FIG. 1: the input node B2, two leaf nodes 23, 24, respectively labeled d3 and d4, and three border or output nodes 13, 14, 15, respectively labeled B3, B4, B5. The output nodes B3 and B4 make it possible to route traffic from the second domain 2 to the third domain 3 via border or input nodes 16, 17, respectively labeled B6, B7. To be more precise, the output node B3 of the second domain 2 is connected to the input node B6 of the third domain 3 and the output node B4 of the second domain 2 is connected to the input node B7 of the third domain 3. The third domain 3 includes a plurality of nodes of which four are represented: the input nodes B6 and B7 and two leaf nodes 25 and 26, respectively labeled d5 and d6. The output node B5 of the second domain 2 makes it possible to route traffic from the second domain 2 to the fourth domain 4 via a border or input node 18, labeled B8, in the fourth domain 4. The fourth domain 4 includes a plurality of nodes three of which are represented in FIG. 1: the input node B8 and two leaf nodes 27, 28, respectively labeled d7, d8.

In the particular example represented in FIG. 1, a point-to-multipoint tree between the root node R and the leaf nodes d1 to d8 is then determined, the leaf nodes being in different domains. By convention, the third and fourth domains 3, 4 are downstream of the first and second domains 1, 2. Reciprocally, the first domain 1 is upstream of the second, third, and fourth domains. The second domain 2 is upstream of the third and fourth domains. The terms upstream and downstream are thus defined relative to the propagation direction from the domain containing the root node R to the domains containing the leaf nodes d1 to d8.

Four path calculation servers 11, 12, 13, 14, respectively labeled PCE1 to PCE4, are responsible for determining paths in the four domains 1, 2, 3, 4, respectively. They store in the storage means 108 the topology of the domain or domains for which they are responsible. They communicate with each other using a Path Computation Element Communications protocol (PCEP) specified by the Internet Engineering Task Force (IETF) in the document draft-ietf-pce-pcep-10.txt, for example.

The method of determining a point-to-multipoint path from a root node to leaf nodes, some of which are in different domains, is described below with reference to FIG. 3.

Below the expression bunch of branches refers to a set of point-to-point or point-to-multipoint paths. A bunch of branches may consist of a plurality of branches or only one branch if it stems from a single root node.

In an initial step that is not shown, the path calculation server PCE1 receives from a client entity a request to determine a point-to-multipoint path. This calculation server PCE1 is referred to below as the initiator calculation server.

A request 30 of this kind is represented in FIG. 2A and includes:
a Typ field 31 representing the type of tree to be determined, i.e. a point-to-multipoint tree in this particular implementation of the invention;
an identifier 32, labeled IdR, of a root node of the point-to-multipoint tree;
a list 33 of leaf node identifiers, labeled d1, . . . , dn;
a point-to-multipoint tree 34, labeled AS1, . . . , ASn, referred to below as the domain tree and representing the tree structure of all the domains and including all the leaf node domains; and
a Mode field 35 representing a tree calculation mode, for example a cost criterion in terms of the number of links used (minimum cost tree (MCT)) or in terms of the path length (shortest path tree (SPT)).

The cost corresponding to the criterion MCT may be an exact minimum cost calculated by an exact or approximate Steiner algorithm using an appropriate heuristic such as that of Takahashi and Matsuyama. The cost of a P2MP tree is the number of links of the tree. The cost of a branch is the number of links of the branch. The following description refers to the Takahashi and Matsuyama algorithm described in the paper by H. Takahashi and A. Matsuyama published in Math. Japonica, vol. 24, 1981 entitled “An approximate solution for the Steiner problem in graphs”.

By definition, the minimum cost path between a node N and a tree A, consisting of a set of nodes, is the path between the node N and a node of A such that the cost of that path is the lowest of the costs of the shortest paths between the node N and the nodes A. The Takahashi and Matsuyama heuristic uses the following procedure to determine the MCT cost of a P2MP tree connecting a root router to a plurality of leaf routers d1, d2, . . . , dn:

Step 1: The start point is a tree initially containing the root R of the P2MP tree.

Step 2: The shortest path between each leaf d1, d2, . . . , dn and that tree is calculated. Of these n paths, that having the minimum cost is chosen, for example the path cj going to the leaf dj, and is added to the P2MP tree, which then contains that path in addition to the root R, and the leaf dj is deleted from the set of leaves.

Step i=3 et seq.: Step 2 is repeated until all the leaves are empty.

If a branch from a bunch of branches is a P2MP tree, the cost is determined by an exact minimum cost or using the Takahashi heuristic, for example. If a branch of a bunch of branches is a point-to-point (P2P) path, the MCT cost represents the cost of the shortest path.

The following description relates to a path calculation server PCEₖ₊₁ referred to below as the current server.

In a step E0 the determination method waits to receive a message. In a reception step E2, labeled R (P2MP, D, PCEₖ), the current path calculation server PCEₖ₊₁ receives from the path calculation server PCEₖ responsible for the upstream domain a request 30 to determine a point-to-multipoint tree.

In a downstream domain determination step E4, labeled Det PCEᵢ, the current calculation server PCEₖ₊₁ determines a list of path calculation servers responsible for one or more downstream domains connected to the current domain from the tree 34 of domains indicated in the determination request 30.

If the current path calculation server is responsible for a destination domain, i.e. if there are no more downstream domains to be contacted, the method proceeds to a step E14 of determining a set of bunches of branches.

If not, i.e. if one or more downstream domains exist, for each downstream calculation server from the list the current path calculation server PCEₖ₊₁ sends the request to determine a point-to-multipoint tree in a sending step E6, labeled S (P2MP, D, PCEᵢ).

Note that the request 30 to determine a point-to-multipoint tree therefore propagates in the upstream to downstream direction as a function of the tree 34 of domains indicated in the determination request.

In a waiting step E8 the method waits to receive response messages to the requests 30 to determine a point-to-multipoint tree.

In a receiving step E10, labeled R (U BBᵢ, PCEᵢ), the current path calculation server PCEₖ₊₁ receives from a downstream path calculation server PCE₁ a response 40 to the request 30 to determine a point-to-multipoint tree.

FIG. 2B shows a response message 40 to such a request sent by a downstream path calculation server PCE₁ of the domain AS₁. It includes:
a Typ field 41 representing the type of tree to be determined, i.e. a point-to-multipoint tree in this particular implementation of the invention;
one or more identifiers of bunches of branches 42, 44, labeled BB₁ and BBᵢ, a bunch of branches including as leaf nodes all the leaf nodes situated in the domain AS₁ and the domains downstream of the domain AS₁ of the downstream server PCE₁ sending the response and as source nodes of the branches of the bunch a subset of the input nodes of the domain AS₁ of the downstream server PCE₁ sending the response; and
one or more costs 43, 45, labeled C₁ and Cᵢ, respectively associated with the bunches of branches BB₁ and BBᵢ.

A bunch of branches identifier includes the subset of input nodes in the domain AS₁ of the downstream server PCE₁ sending the response.

To preserve confidentiality between domains, the path may also be identified by a key known as the confidential path segment (CPS), which is described in the IETF document draft-ietf-pce-path-key-01.txt.

Alternatively, the response message also includes for each bunch of branches an explicit description of its tree structure.

In a test step E12, the current server PCEₖ₊₁ determines whether all response messages from domains downstream of the domain ASₖ₊₁ have been received. If not, the method returns to the step E8 of waiting to receive a message.

If the result of the test in the step E12 is positive, i.e. if all response messages from the path calculation servers of domains downstream of the domain ASₖ₊₁ have been received, the method proceeds to a step E14, labeled D (U BBₖ₊₁), of determining a set of bunches of branches.

In the determination step E14, the current path calculation server PCEₖ₊₁ determines a set of new bunches of branches BBₖ₊₁ for a subset of the input nodes of the current domain (branch source or root nodes), and includes as leaves all leaf nodes in downstream domains and where applicable leaf nodes in the current domain ASₖ₊₁. Each new bunch of branches is determined to minimize the cost function as requested in the request 30 to determine a point-to-multipoint path, taking account of the information relating to the bunches of branches received from the downstream path calculation servers in the receiving step E10. The bunches of branches have input nodes of the downstream domain as roots. The input nodes of the downstream domain are associated with output nodes of the current domain.

By way of illustrative example, it is assumed that two response messages have been received from the path calculation servers responsible for the domains AS₁ and AS₂, the message relating to the domain AS₁ containing a set AB₁ of bunches of branches and that relating to the domain AS₂ including a set AB₂ of bunches of branches. A given subset of input nodes of the current domain is considered. For each possible pair of bunches of branches from the sets AB₁ and AB₂, there is calculated the cost of a bunch including the subset of input nodes of the current domain, the leaf nodes of the current domain, the root nodes of the bunches of branches concerned (respectively in the domains AS₁ and AS₂), and the bunches of branches concerned. The bunch that has the minimum cost function is then retained as the new bunch. The method resumes for a new subset of input nodes of the current domain. The number of iterations is determined as a function of the number of subsets of input nodes of the current domain.

In the particular situation of a path calculation server responsible for a destination domain, the new bunch of branches contains only the leaf nodes in the destination domain. The step E14 is therefore adapted to take account of the specific nature of the current domain.

Once a set bunches of branches consisting of at least one bunch of branches has been determined in the current domain ASₖ₊₁, in a response step E16, labeled S (U BBₖ, PCEₖ₊₁), the current path calculation server PCEₖ₊₁ sends the path calculation server of the upstream domain PCEₖ a response 40 to the request 30 to determine a point-to-multipoint tree containing the identifier or identifiers of the bunches of branches determined in this way and the respective associated costs. The method terminates in the step E18.

Note that the response is therefore sent from calculation server to calculation server in the opposite direction to the determination request until it reaches the calculation server that initiated the request.

The calculation server that initiated the request executes in the same way as its predecessors the step E14 of determining a bunch of branches taking as source node of that bunch a branch of the root node R of the point-to-multipoint tree as specified in the request 30 to determine a point-to-multipoint tree. Note that a point-to-multipoint tree is therefore determined that minimizes the given cost function, this point-to-multipoint tree including leaf nodes in different domains.

In a first variant, the number of bunches is limited to a predetermined value. This first variant nevertheless has the advantage of reducing the necessary calculation time as well as making it possible to determine a point-to-multipoint tree that in this situation is sub-optimal relative to the implementation as described above.

In a second variant, the number of bunches of branches is limited by composing subsets including a single input node as origin node of the bunch with one branch. The bunch is made up of one branch and is a point-to-multipoint or point-to-point tree including an input node of the current domain as origin node. This second variant has the same advantages as the first variant.

The method of the invention is applied next to the particular example shown in FIG. 1. The information relating to costs is not indicated in FIG. 1 in order to avoid overcomplicating it. The situation is the particular one in which the cost criterion corresponds to the number of links used.

The path calculation server PCE1 receives in a step E2 a request to determine a point-to-multipoint tree between the root node R and the leaf nodes d1 to d8.

In a step E6 it forwards this request to the path calculation server PCE2 that in turn forwards it to the path calculation servers PCE3 and PCE4.

The path calculation server PCE3 determines in the step E14 a set of bunches of branches including a first bunch including one branch from the node B6 to the leaves d5 and d6, labeled AB31, of cost eighteen, and a second bunch including one branch from the node B7 to the leaves d5 and d6, labeled AB32, of cost ten. In a step E16 it sends a response message to the server PCE2 containing both these bunches.

The path calculation server PCE4 determines in the step E14 the set of bunches of branches including a bunch including one branch from the node B8 to the leaves d7 and d8, labeled AB41, of cost twelve. In a step E16 it sends a response message to the server PCE2 including this bunch.

The path calculation server PCE2 receives these two response messages and in the step E14 determines a new bunch of branches. There is only one input node B2 in the second domain 2. The server PCE2 determines a first bunch of branches including the input node B2, the leaf nodes d3 and d4 in the second domain, the first bunch AB31 of the third domain 3, and the bunch AB41 in the fourth domain 4. The first bunch of branches therefore also includes the output nodes of the corresponding second domain 2, i.e. the nodes B3 and B5. The part of the first bunch in the second domain 2 has a cost of thirteen, to which must be added the cost in the third domain 3, i.e. eighteen, and the cost in the fourth domain 4, i.e. twelve. This first bunch of branches therefore has a total cost of forty-three.

The server PCE2 then determines a second bunch of branches including the input node B2, the leaf nodes d3 and d4 of the second domain, the second bunch AB32 of the third domain 3, and the bunch AB41 of the fourth domain 4. The second bunch of branches thus also includes the output nodes of the corresponding second domain 2, the nodes B4 and B5. The part of the second bunch in the second domain 2 has a cost of twenty, to which must be added the cost in the third domain 3, i.e. ten, and the cost in the fourth domain 4, i.e. twelve. The second bunch of branches thus has a total cost of forty-two. This second bunch of branches is therefore selected and is sent to the initiator calculation server PCE1 as the bunch of branches AB21. The initiator server PCE1 determines a new bunch of branches in the step E14. The server PCE2 determines a new bunch of branches including the root node R, the leaf nodes d1 and d2 of the first domain, and the bunch AB21 received from the second domain 2. The new bunch of branches therefore also includes the output node of the corresponding first domain 1, the node B1. The part of the new bunch in the first domain 1 has a cost of eight, to which must be added the cost in the downstream domains, i.e. forty-two, so the total cost is fifty.

A path calculation entity 100 is described below with reference to FIG. 4.

The path calculation entity 100 associated with a domain called the current domain for determining a point-to-multipoint tree connecting a root node 10 to a plurality of leaf nodes 21-28, at least some of the nodes being in different domains 1-4, includes:
a module 102, labeled “Rec” in FIG. 4, for receiving at least one message 40 including a first set including at least one identifier of a bunch including at least one branch and a cost 43, 45 associated with said bunch coming from at least one other path calculation entity 12-14 associated with a domain downstream of the current domain, the bunch including at least one branch making it possible to connect to the leaf nodes in downstream domains;
a module 106, labeled “Det” in FIG. 4, for determining at least one new bunch including at least one branch as a function of said at least one first set received, said new bunch of branches having a minimum cost and also making it possible to connect to the leaf nodes of the current domain, if necessary;
a module 104, labeled “S” in FIG. 4, for sending the second set determined to an upstream calculation entity; and
storage means 108, labeled “BD_Top” in FIG. 4, for storing the topology of the domain or domains for which the entity is responsible.

The module 102 is further adapted to receive from another path calculation entity a request 30 to determine a point-to-multipoint tree.

The receiving module 102 and the sending module 104 are adapted to receive and send PCEP messages.

The modules 102, 104, 106 use the above determination method. They are preferably software modules including software instructions for executing the steps of the above determination method executed by a processor of a path calculation entity.

The invention therefore also provides:
a computer program including instructions for executing the above determination method when the program is executed by a processor; and
a storage medium readable by a path calculation entity on which the above computer program is stored.

The software modules may be stored in or transmitted by a data medium. This medium may be a hardware storage medium, for example a CD-ROM, a magnetic diskette or a hard disk, or a transmission medium such as an electrical, optical or radio signal, or a telecommunications network.

The invention further provides a system including a plurality of the above path calculation entities.

The path calculation entity described above may be integrated into a router of the communications network or into a path calculation server.

The description refers to domains equivalent to autonomous systems. It is also possible for the domains to be IGP (Interior Gateway Protocol) areas. In this situation, the edge nodes are at the same time input nodes of one area and output nodes of another area.

1. A method of determining a point-to-multipoint tree connecting a root node to a plurality of leaf nodes, at least some of the nodes being in different domains, executed by a path calculation entity associated with a domain known as the current domain, said method comprising steps of:
receiving from at least one other path calculation entity associated with a domain downstream of the current domain at least one message comprising a first set of identifiers comprising at least one identifier of a bunch of branches comprising at least one branch and a respective cost associated with said bunch, the bunch comprising at least one branch making it possible to connect to leaf nodes in downstream domains; and
determining at least one new bunch of branches comprising at least one branch as a function of said at least one first set received, said new bunch of branches having a minimum cost and making it possible to connect also to the leaf nodes of the current domain if necessary.

2. The method according to claim 1, wherein the number of new bunches is limited to a predetermined number during the step of determining at least one new bunch.

3. The method according to claim 1, wherein the new bunch is limited to one branch during the step of determining at least one new bunch.

4. The method according to claim 1, wherein the step of receiving at least one message comprising a first set of identifiers comprising at least one identifier of a bunch of branches comprising at least one branch and a respective cost associated with said bunch and of determining at least one new bunch of branches including at least one branch and then the step of sending a message comprising a second set of identifiers of the determined new bunch or bunches and a respective cost associated with said new bunch are executed successively from the downstream end to the upstream end by path calculation entities to a path calculation entity associated with the upstream domain comprising the root node.

5. The method according to claim 1, further comprising a step of sending a request to determine a point-to-multipoint tree to path calculation entities associated with domains downstream of the current domain before the receiving step.

6. A path calculation entity associated with a domain, called the current domain, for determining a point-to-multipoint tree connecting a root node to a plurality of leaf nodes, at least some of the nodes being in different domains, said entity comprising means for:
receiving at least one message comprising a first set of identifiers comprising at least one identifier of a bunch of branches comprising at least one branch and a respective cost associated with said bunch from at least one other path calculation entity associated with a domain downstream of the current domain, the bunch of branches comprising at least one branch making it possible to connect to leaf nodes in downstream domains; and
determining at least one new bunch of branches comprising at least one branch as a function of said at least one first set received, said new bunch of branches having a minimum cost and making it possible to connect to the leaf nodes of the current domain, if necessary.

7. A system comprising a plurality of path calculation entities according to claim 6.

8. A node of a communications network comprising a path calculation entity according to claim 6.

9. A computer program comprising instructions for executing the method according to claim 1, for determining a point-to-multipoint tree connecting a root node to a plurality of leaf nodes, at least some of the nodes being in different domains, when the program is executed by a processor.

10. A signal sent by a path calculation entity associated with a domain, said signal bearing a message comprising a set of identifiers comprising at least one identifier of a bunch of branches comprising at least one branch and a respective cost associated with said bunch, the bunch of branches comprising at least one branch making it possible to connect to leaf nodes in domains downstream of the domain and in said domain, if necessary.
